(19) United States
(12) Patent Application Publication
(10) Pub. No.: US 2026/0355847 A1
(43) Pub. Date: Nov. 12, 2026

(54) ARTICLE WITH A COLOUR GRADIENT AND ITS MANUFACTURING METHOD

(71) Applicant: The Swatch Group Research and Development Ltd, Marin-Epagnier (CH)

(72) Inventors: Steve CLERC, Neuchâtel (CH); Yves WINKLER, Schmitten (CH)

(73) Assignee: The Swatch Group Research and Development Ltd, Marin-Epagnier (CH)

(21) Appl. No.: 19/636,227

(22) Filed: Apr. 1, 2026

(30) Foreign Application Priority Data
May 9, 2025 (EP) 25175476.8

(51) Int. Cl. B23K 20/02; B23K 20/22; B23K 103/08

(52) U.S. Cl. CPC B23K 20/023; B23K 20/22; B23K 2103/08

(57) ABSTRACT

A method of manufacturing an article (1) exhibiting, on at least a portion of a face (7) meant to be visible while in use and to a depth of at least 100 μm below the face (7), a colour gradient (1a, 1b, 1c, 1d). The method includes: stacking of several blanks (2a, 2b, 2c, 2d) made respectively in metal alloys distinguished by their chemical compositions and colours; diffusion thermal treatment of the stack of the blanks (2a, 2b, 2c, 2d); and shaping by deformation of the stack and polishing of the shaped stack to obtain the face (7) with the colour gradient.

### CROSS REFERENCE TO RELATED APPLICATIONS

This application claims priority to European Patent Application No. 25175476.8, filed on May 9, 2025, the entire contents of which are incorporated herein by reference.

### TECHNICAL FIELD OF THE INVENTION

The present invention relates to an article, in particular to a solid gold article, exhibiting a colour gradient and to its method of manufacture.

### TECHNOLOGICAL BACKGROUND

There are different ways to obtain colour gradients for a metal material, mainly using powders or thin layers applied for example by PVD (physical vapour deposition). The method with powders requires mixing to obtain the different desired colours, while the PVD method is limited to applying layers without the possibility of manufacturing a product with a colour gradient in bulk.

It is also possible to create a colour gradient using layers of alloys with similar colours, welding them together, and then making a cut perpendicular to these layers. However, the challenge is obtaining a gradual colour transition between these layers. A diffusion by thermal treatment will smooth the transition between the layers but over a short distance of around a few tens of microns. Indeed, the diffusion distance is a function of the square root of the thermal treatment time. This, combined with the low diffusion speeds, makes obtaining a macroscopic transition zone of one millimetre very slow. The transition between colours will therefore not be gradual unless using an extremely long thermal treatment, which is unrealistic from an industrial point of view. A remedy for this problem would be to use a higher number of alloy layers with more similar colours in order to reduce the contrast between two layers. However, this method significantly complicates the process because it requires creating many alloys with different compositions.

### SUMMARY OF THE INVENTION

The invention aims to propose a new method for manufacturing an article exhibiting, on at least a portion of a visible face and to a depth of at least 100 μm, a colour gradient with a gradual transition between colours without using powders, the PVD method or a method that is too long.

The method according to the invention consists of obtaining a colour gradient starting from a stack of layers with a limited area of diffusion between the layers and then geometrically enlarging the area of diffusion on the finished product. More specifically, the stack of layers is subjected to a thermal treatment of reasonable duration to obtain a diffusion zone of a few tens or hundreds of microns between the layers. Then the stack is subjected to deformation to form an inclined surface relative to the plane of the base surface of the stack. The inclined surface, preferably obtained by stamping, is then polished starting from the base surface so as to reveal the colour gradient.

More specifically, the invention relates to a method of manufacturing an article exhibiting, on at least a portion of a face meant to be visible while in use and to a depth of at least 100 μm below said face, a colour gradient, said method comprising the following successive steps:
Providing several blanks made of metal alloys, respectively, distinguished by their chemical composition and colour,
Stacking said blanks to form a stack, said stack being defined with an outer face,
the method further comprising the following successive or concomitant steps:
   Applying stress at room temperature or at a hot temperature to said stack to form a cohesive stack having a thickness E greater than or equal to 100 μm,
   Diffusion thermal treatment between the blanks of said cohesive stack,
   Shaping by deformation, at room temperature or a hot temperature, of the cohesive stack to form an inclined surface relative to the plane of the outer face, the inclined surface extending to a depth P with respect to said outer face,
   Polishing the shaped stack from the outer face to a depth at least greater than the thickness of a blank of the cohesive stack to obtain the face with the colour gradient,
the method further comprising the following optional step:
   Finishing the surface of the face to obtain the article.

The resulting article has a colour gradient present to a depth of at least 100 μm, which ensures its visibility over time regardless of wear and shocks, unlike a colour gradient obtained by PVD where the colour gradient is limited to a thickness of less than 20 μm. The colour gradient can also be present throughout the volume of the article; the depth is easily controlled by selecting the respective thickness of the layers of the stack.

This method provides a simple way to obtain a gradual colour variation between layers with a reasonable diffusion thermal treatment time. Typically, the thermal treatment time is between 1 hour and 6 hours for gold alloys, resulting in a diffusion zone of 100-150 μm that will be spread across the visible face over a distance between 2 and 50 times greater due to the deformation of the base surface.

The invention also relates to the article exhibiting a colour gradient on at least a portion of a visible face and to a depth of at least 100 μm below said visible face, said colour gradient being formed from a set of layers made of metal alloys respectively distinguished by their chemical compositions and colours, said article having a diffusion zone between each layer so as to obtain a gradual variation of the colour between each layer.

### BRIEF DESCRIPTION OF THE FIGURES

FIG. 1 schematically represents the successive steps a) to f) of the manufacturing method according to the invention.

FIG. 2 represents an optional additional step e') of the method of FIG. 1.

FIGS. 3 a), b) represents an optional additional step f') of the method of FIG. 1.

FIGS. 4 and 5 represent two views of a variant of the stamping tool used in the stamping step d).

FIG. 6 schematically represents the diffusion zone between the layers following step c) and its geometric enlargement following steps d) and e).

FIG. 7 represents the EDX measurement of the evolution of the concentration of Cu and Ag between two layers of 2N and 5N gold at the end of step c).

FIG. 8 schematically represents the distance D2 of the diffusion zone between two layers in the depth of the finished article and the distance D1 of the diffusion zone between these same two layers on the visible face of the finished article.

FIGS. 9 and 10 schematically represent the ratio differences between D1 and D2 as a function of the angle of the inclined surface relative to the base surface and as a function of the diffusion thermal treatment time for a given alloy system.

### DETAILED DESCRIPTION OF THE INVENTION

The present invention relates to a method of manufacturing an article exhibiting a colour gradient intended to be visible while in use. The method is particularly suitable for manufacturing an article with a mostly flat surface visible while in use. Thus, the method is particularly suitable for manufacturing a watch component such as a dial, a back, an oscillating mass, a bridge or a bezel.

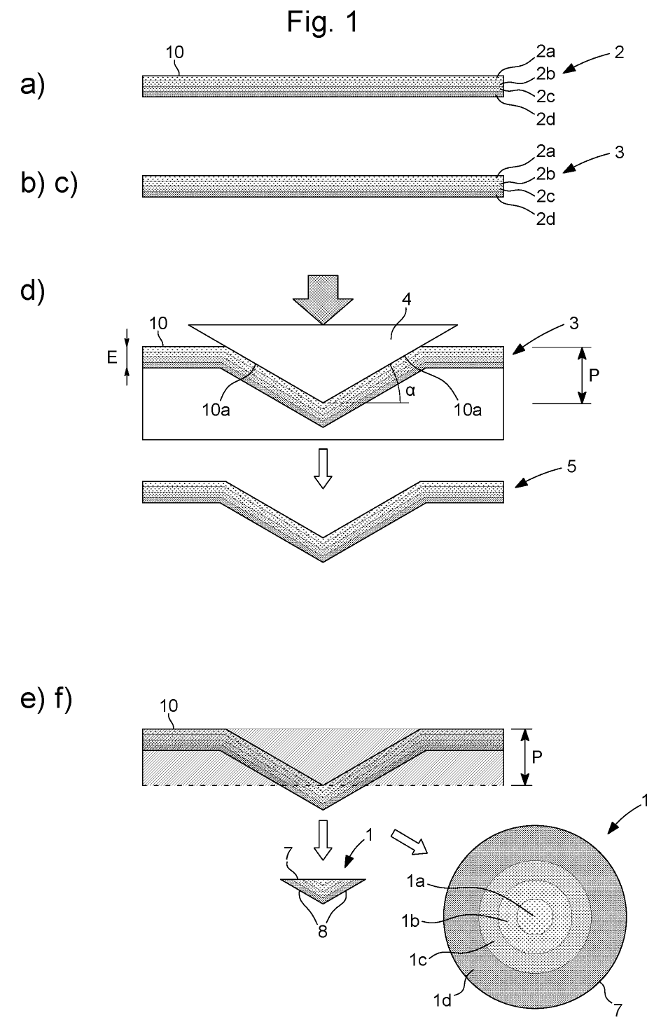

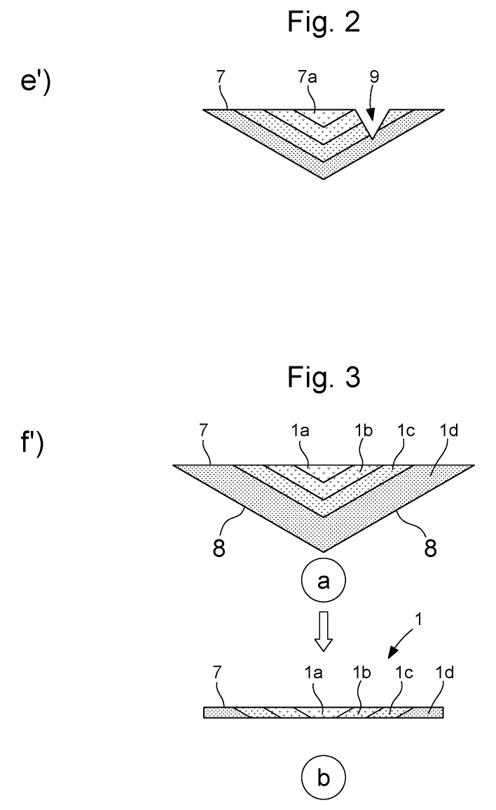

The present invention also relates to the article 1 exhibiting this colour gradient 1a, 1b, 1c, 1d visible in FIGS. 1e) f) on the visible face 7 of the article. Preferably, the colour gradient extends in the same plane as shown in FIGS. 1e) f). It is also possible that the colour gradient be visible in one or more recesses 9 within the visible face 7 as shown in FIG. 2. According to the invention, this colour gradient visible on the surface is also present over a depth of at least 100 μm with a depth that can extend over the entire thickness of the article.

The article is made with metal alloys. More specifically, it may be a solid article in gold alloy with optionally pure gold also, comprising at least two different colour grades. For example, the article can be made with at least two grades classified between 2N and 6N according to the classification established by the Swiss watch industry standards (NIHS). These grades between 2N and 6N have an increasing copper content resulting in an increasingly red colour. They may also include other elements such as Ag. For example, the article may have at least two shades selected from the following colour shades, graded or not: 24K Gold (pure gold), 18K 2N Gold, 18K 3N Gold, 18K 4N Gold, 18K 5N Gold and 18K 6N Gold. Advantageously, the article can be made from four grades which are gradually as follows: 24K Gold (pure gold), 18K 2N Gold, 18K 4N Gold and 18K 6N Gold. Alternative stacks of gold shades are also feasible such as 2N-6N-2N-6N.

In general, the colour gradient may be made with any metal alloy provided that variations in compositions around a base composition make it possible to modulate the colour gradually rather than discretely. It may be possible to work with alloys having different base compositions provided that this gradual colour variation between the different compositions is present after the article is manufactured. The colour gradient includes at least two colour shades with 2, 3, 4, 5, 6, 7, 8, etc. colour shades.

Thus, the article may also be made with alloys of a non-precious metal such as Cu/Cu-Sn, Cu/Cu-Ni, Cu/Cu-As, Cu/Cu-Sb and Cu/Cu-Zn with variations in the composition giving the gradual variation of the colour. For example, for Cu/Cu-Sn, these may be variations in compositions between pure Cu and Cu with 11 % by weight of Sn. For example, for Cu/Cu-Ni, these may be variations in compositions between pure Cu and Cu with 7.9 % by weight of Ni. For example, for Cu/Cu-As, these may be variations in compositions between pure Cu and Cu with 15 % by weight of As. For example, for Cu/Cu-Sb, these may be variations in compositions between pure Cu and Cu with 7.3 % by weight of Sb. For the Cu/Cu-Zn alloy, a gradient was observed at intermediate Zn levels, with a weight percentage of Zn between about 45 % and about 48 % to change from pale yellow to darker yellow. Overall, it is simply important to have a continuous colour change with the composition in order to achieve a gradient and not a discrete jump.

The manufacturing process with its steps a) to f) is schematically presented in FIG. 1. In a first step a), blanks 2a, 2b, 2c, 2d made with variations in composition of a metal alloy are provided and stacked to form a stack 2, defined with an outer face 10, also known as the base surface of the stack. In the example, four blanks 2a, 2b, 2c, 2d, also called layers below, are stacked to form the stack 2. Colour variation can be gradual along the thickness of the stacked layers with colours becoming more intense, or less intense along the thickness. It is also possible to stack a first set of layers with a gradual variation of colours on a second set of layers having a gradual variation of colours, the gradual variation of colours for each set becoming more or less intense, or one set becoming less intense and the other set becoming more intense. It is also possible to alternate layers with varying intensities such as: 4N-3N-5N-2N or 2N-3N-2N-5N in the case of gold and its alloys. It is also possible in a stack with at least three layers to put two layers of the same composition with one or more other layers between.

The number of layers, their respective thicknesses, the alloys in question, and their geometries are chosen based on the desired result and the application. For example, the blanks may be in the form of discs to form an article 1 with a colour gradient in concentric circles 1a, 1b, 1c, 1d corresponding respectively to the shades of the blanks 2a, 2b, 2c, 2d (FIGS. 1e) f)). It will be understood that any geometry (square, rectangular, annular, etc.) can be considered. For example, blanks can be in the form of strips. In addition, blanks may be first polished or subjected to another surface treatment such as chemical etching, to improve the interface between the blanks.

According to the method, the thickness of each layer is not a limiting factor. It can be variable from one layer to another as long as all of the layers have a thickness greater than or equal to 100 μm. Each layer may have a thickness of between a few microns, even tens of microns and several millimetres or more. For example, in the case of a dial or a back, the total thickness of the stack is between 0.2 mm and 4 mm with a thickness of between 0.05 mm and 2 mm for each layer. It is also possible to have a much thicker layer, for example the last layer 2d that will delineate the opposite face to the visible face. For example, the last layer 2d may have a thickness of 10-15 mm with the top layers having a thickness of several tens of microns. An application would be for a dial with a lower half of the thickness of the dial formed of a layer and with an upper half formed of several layers thereby forming the colour gradient only on one half of the thickness of the dial. The last layer may also have a thickness greater than that of the top layers for reasons of machinability in step f') as described below. For example, for machinability reasons in the case of a dial, the bottom layer 2d may have a thickness of 0.9 mm while all of the top layers have a total thickness of 0.9 mmto be divided by the number of layers, for example 2 or 3.

In a second step b), all of the stacked layers are subjected to stress, preferably at a hot temperature, to weld layers 2a, 2b, 2c, 2d together and thereby form a cohesive stack 3. Different consolidation techniques are possible. Some examples include flash sintering (SPS for Spark Plasma Sintering), roll bonding, coextrusion, ultrasonic welding with stress applied by a press, joule-effect welding with stress also applied by a press, etc. For example, blanks in the form of strips in step a) may be roll bonded. This roll bonding could be followed by sizing, for example, by stamping the consolidated stack to obtain the desired shape, for example a circular shape.

The pressure and temperature depend on the metal alloys and the geometry of the blank. Typically for a set of layers based on gold alloy and optionally pure gold, the temperature is between room temperature and 890° C, preferably between 350° C and 870° C and more preferably between 400° C and 650° C with a pressure between 1 MPa and 1000 MPa, preferably between 5 MPa and 350 MPa, more preferably between 50 MPa and 250 MPa. The application time of the stress may be between 10 seconds and 48 hours, preferably between 5 minutes and 2 hours, more preferably between 10 minutes and 1 hour. This step may be performed under an inert atmosphere or under a controlled atmosphere in order to improve the results depending on the alloys.

In a third step c), a thermal treatment is performed to create a chemical diffusion between layers 2a, 2b, 2c, 2d to obtain a colour gradient between layers instead of a discrete separation line. Again, the temperature of the thermal treatment will be dependent on the material. For example, for a set of layers based on gold alloy and optionally pure gold, the temperature is between 700° C and 890° C. The treatment time may be between 1 minute and several tens of hours, with the maximum time being limited solely to profitability. Thus, preferably, the treatment time is optimally between 1 hour and 8 hours and more preferably between 1 hour and 6 hours. In general, regardless of the type of alloy, the temperature and the treatment time are adapted to obtain a diffusion distance between two layers between 10 μm and 400 μm, preferably between 100 μm and 250 μm. It will be specified that this thermal treatment may also be used, depending on the alloys, to obtain particular properties, for example, hardening. This thermal treatment could also be accompanied by quenching or carried out under a specific atmosphere as needed.

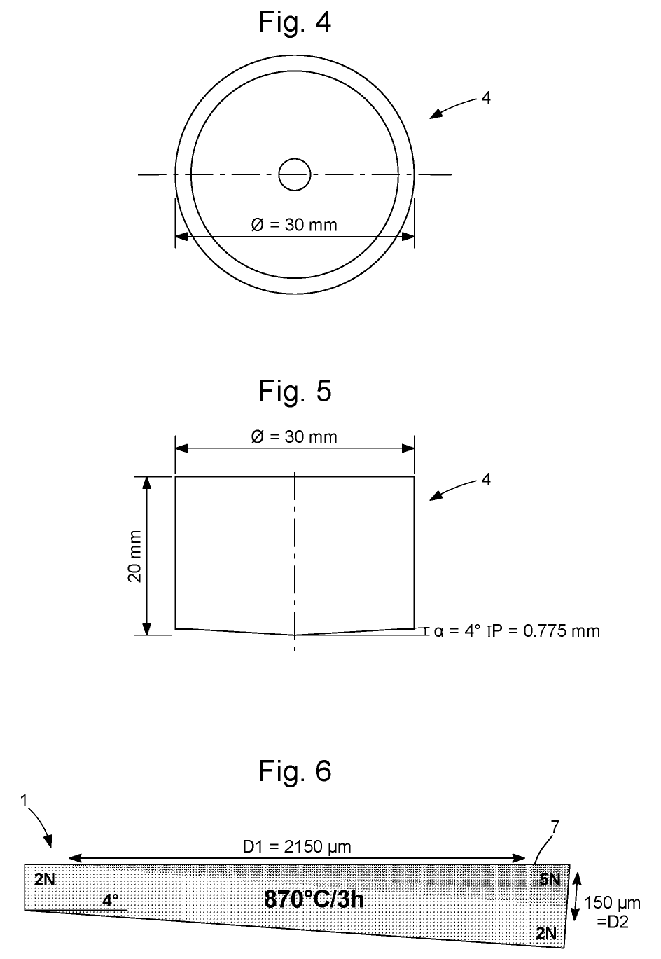

In a fourth step d), the stack 3 is shaped by hot or cold deformation in order to form an inclined surface 10a with respect to the plane of the upper face 10. In the case of a planar inclined surface 10a, it is inclined at an angle α preferably between 0.1° and 40°, more preferably between 0.5° and 20°, even more preferably between 1° and 10°. This inclined surface extends from the upper face 10 to a depth P. In the example shown, shaping is done by stamping with a stamping tool 4 whose shape may vary depending on the desired result. For example, the tool 4 may be conical with an angle α relative to the plane of the outer face 10 of the stack (FIGS. 4 and 5). This conical shape makes it possible to obtain circular gradients in a plane that is parallel to the plane of the outer face of the stack on the final article. For example, the stamping tool could also be spherical, in the form of two planes inclined from the top, etc. For this step, other than stamping, other shaping techniques such as folding, twisting, etc. may be considered. Again, the pressure and temperature are dependent on the material. Typically for a set of layers based on gold alloy and optionally pure gold, the temperature is between room temperature and 890° C, preferably between 350° C and 870° C and more preferably between 400° C and 650° C with a pressure between 1 MPa and 1000 MPa, preferably between 5 MPa and 350 MPa, more preferably between 50 MPa and 250 MPa. The application time of the stress can be between 1 minute and several hours, the maximum time not being limiting.Again,if the deformation is carried out at a hot temperature, the thermal treatment may be used to obtain specific mechanical properties and carried out under a specific atmosphere.

According to a variant of the method, it should be noted that steps b), c) and d) can be performed in a single step. This is known as concomitant steps.

In a fifth step e), the shaped stack 5 is polished. It should be specified that the polishing may not be completely planar if, for example, the goal is to create a domed surface (e.g. for a dial). The polishing is performed from the outer face 10 to at least a depth greater than the thickness of a layer of the stack to reveal all or part of the gradient. Preferably, it is carried out over at least a depth corresponding to the thickness E of the consolidated stack 3 to reveal the entire gradient. In the case of polishing to a depth between a thickness greater than the thickness of a layer and a thickness less than the depth P, the resulting face 7 is hollowed out in its centre, which subsequently makes it possible to make a ring. To obtain a face 7 that is not hollowed out, polishing will be carried out to the depth P or beyond. The polishing may be planar to form a flat or domed surface if required by the geometry of the final article.

There is then an optional sixth step f) for surface finishing, such as polishing, microblasting, sandblasting, satin finishing and/or sunray finishing, etc. carried out for example mechanically or by laser. Chemical and/or electrochemical etching can also be carried out to create particular effects.

The article 1 thus obtained seen in FIGS. 1 e) f) presents on its face 7 the colour gradient 1a, 1b, 1c, 1d in a plane parallel to that of the outer face of the stack. In the case of stamping, the article has a section corresponding to the section of the stamping tool. Depending on the desired shape of the article, the face 8 opposite the face 7 may be polished, coated in a resin or more generally sized in an optional step f'). In the case of a dial or a back, for example, the last layer 1d will preferably have a greater thickness than layers 1a, 1b, 1c as illustrated in FIG. 3 so that the edges of the layer 1d are thick enough to be machined by leaving this layer visible on the face 7 (FIG. 3a). Face 8 may also be machined to be parallel to face 7 (FIG. 3b).

Optionally, the method may comprise between steps e) and f) a step e') consisting of forming one or more recesses 9 by grinding, laser ablation or local milling of the face 7 to reveal the colour gradient at another angle. This recess 9 visible in FIG. 2 has an inclined surface, for example in a V shape. The final face 7 of the article is therefore no longer completely planar. It is formed of a planar part 7a with a view of the colour gradient and one or more recesses 9 where the colour gradient appears at another angle.

It should be noted that additional thermal treatment steps may also be carried out at different times in the process in order to optimise the mechanical or aesthetic properties of the obtained article.

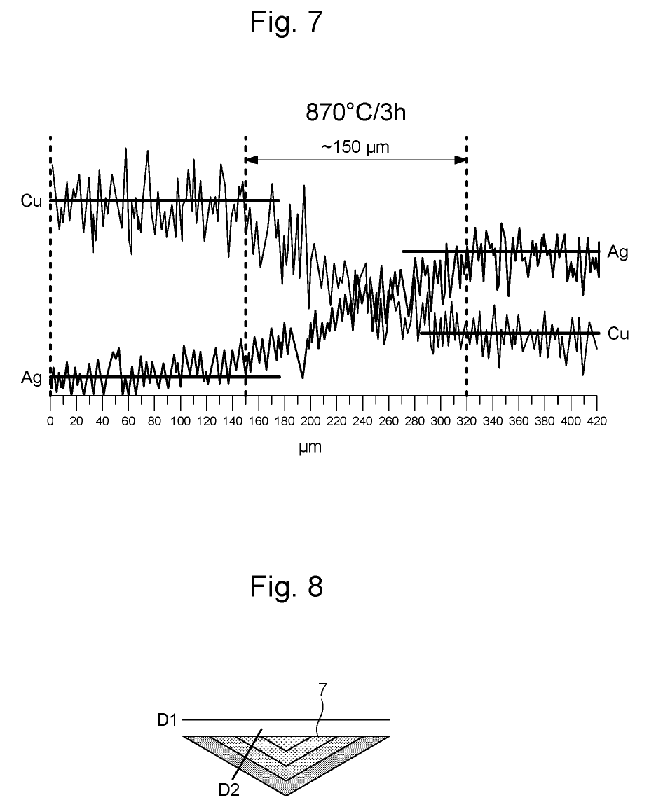

Through the invention, the diffusion zone obtained in step c) which typically has a magnitude of a few tens of microns is spread out on the visible face 7. An illustration of the principle is as follows. Two layers of 2N and 5N Gold alloy were hot-pressed welded. Diffusion thermal treatment was then performed at 870°C for 3 hours. It can be seen in FIG. 7 that the diffusion zone of the Cu and the Ag measured along a line, for example, by EDX (Energy Dispersive X-ray) perpendicular to the layers is about 150 μm, 170 μm to be precise. Then, the blank was hot-stamped with a cone with an α angle of 4°. The stamped blank has been polished to reveal the colour gradient. As shown in FIG. 6, the diffusion zone of a distance D2 in the order of 150 μm between two layers is thus spread over a distance D1 of about 2150 μm. As a comparison, more than 600 hours of thermal treatment at 870° C would be required to obtain the same transition distance using only diffusion.

According to the invention, the ratio between the distance D1 of the diffusion zone visible on the face 7 following step e) and the distance D2 of the diffusion zone following step c) is between 2 and 50, preferably between 5 and 20 (FIG. 8). On the final article, the distance D2 can be measured, for example, based on an EDX measurement within the sample, i.e. on the basis of a destructive test. This distance D2 is measured along a line that is perpendicular to the layers. If the different layers are no longer easily separable, this distance D2 will correspond to the smallest distance of diffusion zones obtained on different sections through the article. In other words, if the layers are no longer easily separable, the distance D2 corresponds to the distance between the place of composition c1 and the place of composition c2, the compositions c1 and c2 being the nominal compositions of the initial layers. The same will apply for the distance D1. The distance D1 for calculating the ratio corresponds to the diffusion distance between two corresponding layers on the face 7, this measurement being performed along a line, again perpendicular to the layers, i.e. in the case of concentric layers, perpendicular to the tangents of the circles.

Typically, D1 is between 20 μm and 20 mm, preferably between 0.5 mm and 5 mm and D2 is between 10 μm and 400 μm, preferably between 100 μm and 250 μm.

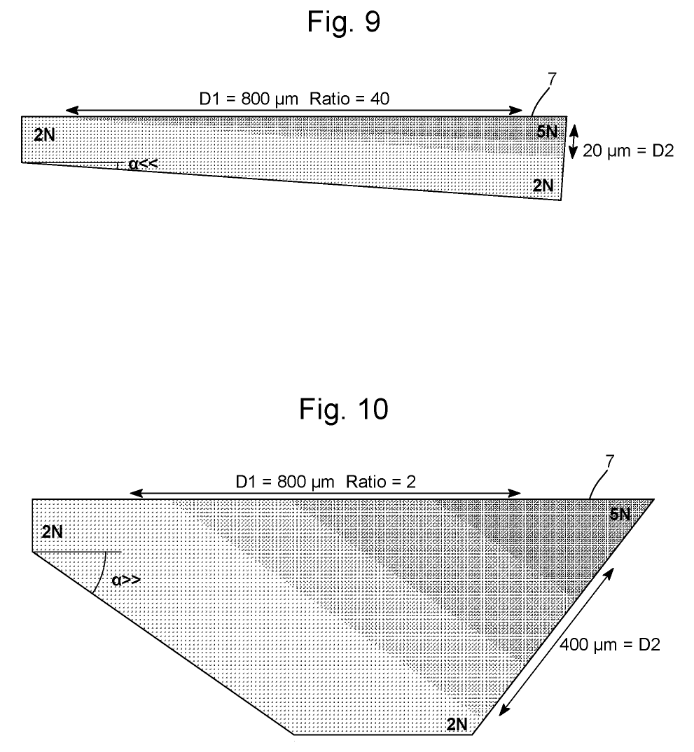

The ratio between D1 and D2 depends on the angle α of the inclined surface following the deformation, or in other words on the angle α of the stamping tool in the case of deformation by stamping. The effect of the angle α and the diffusion thermal treatment time is illustrated schematically in FIGS. 9 and 10 for a stack of two layers of 2N and 5N gold alloy. In the example in FIG. 10, the diffusion distance D2 is significant with a value of about 400 μm following a long thermal treatment of several hours. Then, the outer face of the stack was stamped with a high angle α of the tool, typically greater than 20°. A ratio of 2 is observed with a distance D1 of 800 μm on the visible face 7. On the contrary, in the example in FIG. 9, the treatment time is short, typically less than 2 hours, leading to a low diffusion distance D2 of about 20 μm. The deformation was then carried out with a low α angle of less than 1°. The same distance D1 of 800 μm is then observed on the visible side, i.e. a ratio between D1 and D2 of 40. Each approach has advantages and disadvantages. The approach in FIG. 10 is not necessarily ideal because it requires a long diffusion thermal treatment. On the other hand, an open deformation angle is more practical in production because it minimises the visual differences obtained with a variation in polishing depth. The advantage of the approach in FIG. 9 is that the thermal treatment time is short, which is economically more advantageous. On the other hand, a very closed deformation angle can be problematic in production because it increases the visual differences obtained with a variation in polishing depth. There is a compromise to be found on a case-by-case basis.

The method was implemented for a solid gold article starting from four stacked gold discs with, successively, the following shades of gold: 24K Gold (pure gold), 18K 2N Gold, 18K 4N Gold, 18K 6N Gold.Each disc had a thickness of 0.3 mm and a diameter of 30 mm. The discs were first polished to improve the interface. They were then hot-pressed at 550° C under 141 MPa pressure for 90 minutes to obtain the cohesive stack. Then, a thermal treatment of the stack was performed at 870° C for 5 hours in a protective atmosphere. The stack was pressed with a conical tool at 550° C under 141 MPa pressure for 30 minutes. The stack was then polished to obtain the circular plane with the colour gradient and then the surface finish of the circular plane was improved by microblasting. FIGS. 4 and 5 represent two views of the conical tool 4 used for stamping. The tool had a diameter of 30 mm corresponding to the diameters of the discs and an indentation depth of 0.775 mm with an α angle of 4°.

A very nice aesthetic rendering was obtained with a gradual variation in the colour from bright yellow from pure gold to pink from 18K 6N gold.

1. A method of manufacturing an article exhibiting, on at least a portion of a face meant to be visible while in use and to a depth of at least 100 μm below said face, a colour gradient, said method comprising the following successive steps:
Providing several blanks respectively made in metal alloys, distinguished by their chemical composition and colour,
Stacking said blanks to form a stack, said stack being defined with an outer face,
the method further comprising the following successive or concomitant steps:
Applying stress at room temperature or at a hot temperature to said stack to form a cohesive stack having a thickness E greater than or equal to 100 μm,
Diffusion thermal treatment between the blanks of said cohesive stack,
Shaping by deformation, at room temperature or a hot temperature, of the cohesive stack to form an inclined surface (10a) relative to the plane of the outer face, the inclined surface (10a) extending to a depth P with respect to said outer face,
Polishing the shaped stack from the outer face to a depth greater than the thickness of a blank to obtain the face with the colour gradient,,
the method further comprising the following optional step:
Finishing the surface of the face to obtain the article.

2. The method according to claim 1, wherein the blanks are produced in bulk from distinct gold alloys with optionally one blank produced in bulk from pure gold.

3. The method according to claim 2, wherein, for the stressing step and the deformation step, the temperature is between room temperature and 890° C. with a pressure between 1 MPa and 1000 MPa.

4. The method according to claim 2, wherein, for the diffusion thermal treatment step, the temperature is between 700° C. and 890° C. with a treatment time between 1 minute and several tens of hours.

5. The method according to claim 1, wherein the step of shaping by deformation is carried out using a stamping tool in a conical shape so as to form a colour gradient in concentric circles on the face.

6. The method according to claim 1, wherein the polishing step is performed at least to a depth equal to the thickness E of the cohesive stack to obtain the face with the colour gradient.

7. The method according to claim 1, wherein the polishing step is performed over at least the depth P from the outer face.

8. The method according to claim 1, comprising an additional step of local machining of the face after the polishing step to form at least one recess (9) on said face.

9. The method according to claim 1, wherein the inclined surface is inclined at an angle α relative to the plane of the outer face, the angle α being between 0.1° and 40°.

10. The method according to claim 1, comprising, after the polishing step, a step of sizing at least one other face opposite the face to form the article.

11. The method according to claim 1, wherein the stack includes at least 3, preferably at least 4 blanks.

12. The method according to claim 1, wherein within the stack of the blanks, the blank in the lowest position relative to the outer face has a greater thickness than the other blanks.

13. An article with a colour gradient visible on at least a portion of a face of the article and extending over a depth of at least 100 μm below said face, said colour gradient being formed of a set of layers respectively made in metal alloys, distinguished by their chemical composition and colour, all of the layers having a measurable diffusion zone, in particular by Energy Dispersive X-ray technology between each layer in order to obtain a gradual variation of the colour across all of the layers.

14. The article according to claim 13, wherein the diffusion zone between two layers on the face extends over a first distance D1, said diffusion zone between these same two layers extending over a second distance D2 over said depth of at least 100 μm below said face with a ratio between D1 and D2 of between 2 and 50, wherein the first and second distances D1 and D2 are measured by Energy Dispersive X-ray technology along a line perpendicular to the two layers.

15. The article according to claim 14, wherein D1 is between 20 μm and 20 mm and for which D2 is between 10 μm and 400 μm.

16. The article according to claim 13, having, over its full depth, said colour gradient.

17. The article according to claim 13, wherein all of the layers are made with variations of one of the alloys selected from the list of Gold/Gold-Cu, Cu/Cu-Sn, Cu/Cu-Ni, Cu/Cu-As, Cu/Cu-Sb and Cu/Cu-Zn alloys.

18. The article according to claim 17, wherein all of the layers are made with variations of Gold/Gold-Cu alloys and wherein all of the layers comprise at least two layers made with two gold shades selected from 24K Gold, 18K 2N Gold, 18K 3N Gold, 18K 4N Gold, 18K 5N Gold and 18K 6N Gold.

19. The article according to claim 18, wherein all of the layers comprise four layers made with four gold shades which are successively 24K Gold, 18K 2N Gold, 18K 4N Gold and 18K 6N Gold.

20. The article according to claim 13, comprising on the face concentric circles with a gradual variation of the colour from circle to circle.

21. The article according to claim 13, comprising in the same plane on the face the colour gradient.

22. The article according to claim 13, comprising on the face a planar portion with the colour gradient and one or more recesses revealing the colour gradient present to a depth of at least 100 μm.

23. The article according to claim 13, said article being a dial, a back, an oscillating mass, a bridge or a watch bezel.

24. The article according to claim 23, wherein the layer most opposite to the face is visible at a thickness greater than the other layers.
